(19) United States
(12) Patent Application Publication
(10) Pub. No.: US 2024/0083669 A1
(43) Pub. Date: Mar. 14, 2024

(54) COOLING CONTAINER AND COOLING METHOD, IN PARTICULAR FOR ICE CREAM

(71) Applicant: INTELLECTUAL PROPERTIES TRADING UG (HAFTUNGSBESCHRÄNKT), Weilerswist (DE)

(72) Inventor: Andreas SIEBRECHT, Erftstadt (DE)

(21) Appl. No.: 18/022,782

(22) PCT Filed: Aug. 25, 2021
(86) PCT No.: PCT/EP2021/073531

§ 371 Date: Feb. 23, 2023

(30) Foreign Application Priority Data
Aug. 25, 2020 (DE) 10 2020 122 225.4
Feb. 17, 2021 (DE) 10 2021 103 760.3

(51) Int. Cl. B65D 85/78; B65D 81/38; F25D 3/08

(52) U.S. Cl. CPC B65D 85/78; B65D 81/3823; F25D 3/08; F25D 2303/0831

(57) ABSTRACT

The invention relates to a method for cooling a product, in particular an ice cream product, in which at least one cooling element (6, 7) is introduced into a cooling section of a cooling container and in which the product is introduced into a receiving space of the cooling container. The invention further relates to a corresponding cooling container.

The task of the invention is to create a method and a container for cooling a product, e.g. a ready-decorated ice-cream product, which takes into account the special properties of various product components and enables the product to be transported and delivered in optimum condition.

This task is solved by dividing the receiving space into two zones and cooling the first, lower zone of the receiving space to a first temperature below −10° C. and cooling the second, upper zone of the receiving space to a second temperature that is near or above the freezing point of water.

The invention relates to a method for cooling a product, in particular an ice cream product, in which at least one cooling element is introduced into a cooling section of a cooling container and in which the product is introduced into a receiving space of the cooling container. It further relates to a corresponding cooling container.

Cooling containers for transporting ice cream are known, for example, from DE 297 07 280 U1. Here, a transport container for filled ice cream wafers and ice cream cups is described. The transport container consists of a foldable sleeve made of cardboard material or plastic, in which an inner part is arranged which holds the ice cream cup or ice wafers. A slide-in compartment may be provided in the cavity for holding a cold pack. The transport container is intended to allow the transport of freshly prepared ice portions in ice cream wafers and ice cream cups without loss of quality.

The document JP 2004 067 116 A disclosed a container for delivering an ice cream product. This packaging has two cups joined into each other. The lower cup contains the ice cream and the upper cup contains a juicy confectionery, the upper cup serving as a lid for the lower cup.

The document US 2020/0072523 A1 describes a two-stage dry ice system for storing perishable goods during transport. The dry ice is associated with a PCM material (phase change material), which has a higher cooling temperature. Dry ice and PCM material divide the container centrally into a holding space adjacent to the dry ice with a very low temperature and a holding space adjacent to the PCM module with a slightly higher temperature. US 2020/0008623 A1 discloses a drinking container with two temperature zones in which a beverage is held at two different temperatures, namely an inner high temperature zone and a lower consumption temperature zone arranged towards the outlet opening. Coolers with receptacles for cooling elements, which divide the interior of the cooler into differs ent zones, are known from the documents DE 87 13 329 U1, DE 10 2016 107 813 B3, EP 3 090 961 A1 and U.S. Pat. No. 4,294,079 A. US 2020/0148409 A1 describes an insulated cardboard box for refrigerated products. KR 20-0357645 Y1 relates to a receiving container for ice cream cups with a receiving space for dry ice above the ice cream cups. CN 211168094 U deco scribes an ice cream container with a hollow lid, in the cavity of which a cooling element is integrated and KR 1020160008816 A describes an ice cream cup which has a cooling space in the base for receiving dry ice.

The problem of the invention is to create a method and a container for cooling a product, e.g. a ready-decorated ice-cream product, which takes into account the special properties of various product components and enables the product to be transported and delivered in optimum condition.

According to the invention, this problem is solved by dividing the receiving space into two zones and cooling the first, lower zone of the receiving space to a first temperature below −10° C. and cooling the second, upper zone of the receiving space to a second temperature which is close to or above the freezing point of water.

Consequently, instead of proposing two different containers for separately holding two different product components, the holding space for holding the composed ready-to-eat product is divided into two zones that can be cooled to two different temperatures. At the same time, the cooling container remains transportable and does not require an external power supply.

This proposal is based on the fundamental consideration that high-quality ice cream products often have decorative elements or additional ingredients in addition to the ice cream, which require a different temperature than the ice cream itself. As a rule, the optimum temperature for ice cream is below −10° C., for example −14° C. At this temperature, the ice cream has a firm, yet tender and not hard consistency. If the temperature of the ice cream is lower, it becomes too hard and loses flavor. At a higher temperature, it becomes too soft and runs the risk of melting prematurely. In contrast, additional elements applied to the ice cream, such as fruit, fruit sauces, cream, chocolate or fine pastries, have a much higher optimum consumption temperature, e.g. refrigerator temperature in the range of 0 to 7° C. Cream in particular should not be cooled below freezing point, because otherwise the components will separate during subsequent thawing and the cream will lose its desired consistency. Fruits and fruit sauces also change their consistency at temperatures below freezing point and lose their flavor when subsequently thawed above freezing point. In particular, fruits such as strawberries become watery or mushy due to loss of fruit juice during thawing.

For this reason, a cooling container is proposed as a transport container that has at least one contiguous receiving space with two zones for the product that can be cooled to different temperatures. The first, lower zone, which receives an ice cream cup or ice cream cone, is cooled to the optimum consumption temperature of the ice cream. The second, upper zone is cooled to a temperature that is near or above freezing to prevent loss of quality due to excessive cooling of additional elements of the ice cream product located in this second zone. Consequently, the ice cream product is maintained at a constant optimum consumption temperature within the container. Consumption immediately after removal from the cooling container therefore provides the customer with the optimum consistency and flavor of the ice cream product as when consumed in an ice cream parlor immediately after its preparation.

In practice, at least one first cooling element having a first temperature may be introduced into a first cooling section of the cooling container adjacent to the first zone, and at least one second cooling element having a second temperature may be introduced into a second cooling section of the cooling container adjacent to the second zone. Cooling elements are also referred to as cold packs and include a cooling liquid. The cooling liquid is cooled to a certain temperature. During a certain period of time, the cooling liquid maintains the temperature, thereby maintaining a low temperature in the vicinity of the cooling element. For example, if the cooling container is ins tended to receive an ice cream product in a cup having cream and fruit disposed on the top thereof, the first cooling zone may be located in the lower portion of the cooling container that receives the cup of ice cream and the second cooling zone may be located in the upper portion of the cooling container that receives the cream and fruit.

In particular, cooling elements are also known whose cooling liquid undergoes a phase change. Such cooling liquid is also called PCM material (phase change material). Such a cooling liquid is characterized by particularly effective cooling at a predetermined temperature. In practice, cooling elements with different cooling liquids can be used for cooling the different zones. The phase change temperature of the cooling liquid in the cooling element in the first cooling section, which cools the ice cream, is below −10° C., preferably in the range between −14 and −18° C. The phase change temperature of the cooling liquid of the cooling element in the second cooling section, on the other hand, can have a significantly higher value and cause cooling of the second cooling section to refrigerator temperature, e.g. between 0 and 7° C.

In practice, the first cooling section and the first zone may be arranged in a base body of the cooling container, with the second cooling section and the second zone being arranged in a lid of the cooling container. In this case, the product is placed in the base body and the lid is placed on the base body in such a way that the receiving space is closed. The base body thus surrounds the cup or wafer with the ice cream inserted therein. The lid surrounds the area above the cup, on which additional elements such as cream, sauce and pieces of fruit are usually placed.

In practice, an insert may be placed in the base body and a dome-shaped cover cap may be placed in the lid and the cover cap may be latched to the base body or to the insert. The additional elements on an ice cream cup are often very delicate. Particularly when cream, sauces and pieces of fruit are arranged decoratively on an ice cream cup, care must be taken to ensure that, after the ice cream cup has been arranged, there is in particular no contact between the cooling container and these decorative additional elements. This danger is eliminated by proposing, for holding the cup, a base body which forms the lower part of the cooling container and in which an insert is provided which fixes the cup. The second cooling section is arranged in a lid of the cooling container, in which the second cooling element is accommodated. The second cooling section is separated by a cover cap, for example made of transparent plastic, from the zone of the receiving space in which the decorative elements are located. The cover cap is latched to the insert or the base body so that it is held in position. This reliably prevents the decorative elements from being contacted from the outside, in particular by the cooling container, and thus damaged. The cover cap can also be used for temperature control in the second upper zone. For example, the cover cap can be made of insulating material that shields the decoration elements located on top of the ice cream product from an excessive cooling effect of the cooling element or elements in the cooling container. However, the cover cap may itself be double-walled and enclose a cavity that is filled with PCM cooling liquid. The PCM cooling liquid in the cover cap is then cooled to a temperature close to freezing point and maintains the target temperature in the second zone of the receiving space for the ice cream product, which is significantly higher than the temperature in the first zone.

In practice, two mutually complementary latching elements can be engaged with one another, which are arranged on the cover cap on the one hand and on the insert or the base body on the other, at least one latching element being arranged on a displaceable wall and the latching being released by changing the position of the wall. For example, the cover cap may have a protruding rim which latches with a slot of the insert or the base body. As will be discussed below, the insert and base body preferably comprise a folded cardboard blank. The slot may be located in a perforated area of the insert or the base body that can be torn out. By tearing out this area, the latching connection can be released. However, the slot can also be arranged in an area of a crease line along which an element of the base body or the insert is folded when the cooling container is joined together. By folds ing said element back, the latching projection received in the slot can be released. A practical embodiment of this proposal is described in detail below.

In practice, a pull element can be arranged in the cooling container and the product can be moved out of the base body by pulling the pull element. Usefully, the cooling container is a closed body, for example in the form of a cuboid or a cylinder. The base body forms one half of the container, in which the ice cream cup is accommodated. The lid forms the second half of the cooling container, which covers cream, fruit, sauce and other decorations on the ice cream. After the lid is removed, the decoration on the ice cream is exposed. However, it is not possible to grab the cup without touching the decoration and damaging it. For this reason, a pull element is proposed to move the product out of the base body.

In practice, the first zone can be cooled to a temperature below −10° C., preferably to a temperature of about −14° C. The temperature in the second zone differs from this. In particular, in the preferred use for transporting an ice cream product having the ice cream in the cup and cream, fruit pieces and fruit sauces on the cup in the second zone, the second zone can be cooled to a temperature of about 0° C. or slightly above. This allows the finished ice cream product to be prepared ready for consumption and then transported to the customer. Because of the cooling by the cooling elements to the optimum consumption temperature, it is possible to keep the ice cream product at the optimum consumption temperature for a long period of time, for example 30 min to 60 min, and thereby maintain the optimum consumption consistency. This cooling process consequently makes it possible to package ice cream products ready for consumption even in warm countries, e.g. Arabian or African countries, as well as in summer temperatures, and then to deliver them to the customer via a delivery service—without any loss of quality. The ice cream product remains at its optimum temperature for a standard delivery period of 30 minutes, or a maximum of 60 minutes. During this time, the ice cream maintains its consumption temperature of approx. 14° C. and the cream and/or fruit of approx. 0 to 7° C. The ice cream product is ready for consumption immediately after removal from the receiving space.

In a variation of the cooling method, the receiving space may include at least one region having a plurality of walls. A cooling fluid may be introduced into a cavity formed between the walls. In this way, the cooling element is permanently introduced into the cavity between the walls. Alternatively, a medium having low thermal conductivity can be filled into the cavity between the walls for thermal insulation of the receiving space. In this embodiment, the cavity acts as an insulator and reduces heat exchange with the environment. This variation with at least one cavity formed by the walls of the receiving space is preferably intended for repeated use. The walls forming the cavity may be made of resistant material such as plastic or metal. By filling the cavity with one of the media specified above, the cavity integral to the package in either have a cooling or an insulating effect. When the cavity is filled with air, which has low thermal conductivity, it thermally insulates the receiving space of the cooling container. If the cavity is filled with a cooling liquid, in particular a phase change material, it acts as a temperature accumulator and causes the temperature to which the cooling container is cooled to rise only slowly. Of course, as described further below, two cavities can also be formed, of which an outer cavity surrounds an inner cavity. The outer cavity can then contain the thermally insulating medium. The inner cavity can be filled with the cooling liquid.

Accordingly, the invention also relates to a cooling container having at least one receiving space for a product and a cooling sector adjacent to the receiving space for receiving a cooling element. In order to be able to optimally cool a sensitive product, such as an ice cream product, which has different components at different temperatures, at least two cooling sectors adjoin the receiving space, into which cooling sectors cooling elements can be introduced which cool the receiving space to two different temperatures in at least two zones.

The cooling container preferably has an insulating outer wall that keeps the cold inside the cooling container and protects the two zones from heating up too quickly. An outer wall made of corrugated cardboard meets these requirements. The outer wall can also be multilayered to improve insulation.

In practice, the cooling container may comprise a base body made of a thin-walled material having a first zone for receiving a cup surrounded by a first cooling sector. Further, the cooling container may comprise a lid made of a thin-walled material having a second zone surrounded by a second cooling sector. Both base body and lid may be formed from a blank of corrugated cardboard formed along crease lines to form the respective elements of the cooling container. Both base body and lid may have multi-layered walls to increase insulation through the wall material.

In practice, the base body of the cooling container may have an insert that holds the cup in the first zone. This insert may also be formed as a folded cardboard blank. However, the insert may also be a more durable and reusable part, for example made of metal or plastic. In particular, the insert may have a cavity surrounding the cup, which is filled with PCM cooling liquid. The insert itself can thus be designed as a cold pack. It is then cooled to the required temperature of the ice cream and cools the cup, which is surrounded by the cavity of the insert with little clearance. In particular, the insert can be designed such that an upper rim of the cup can be freely grasped to remove the cup from the insert. However, for such a complex insert, it is preferable that the insert be usable multiple times. The insert can be returned to the supplier after the ice cream product has been delivered, preferably with the remainder of the packaging, so that it can be used multiple times for delivering ice cream. Similarly, a cover cap may be formed within the lid with a cavity to receive a cooling liquid that is cooled to the higher temperature in the second cooling zone having the higher temperature.

The lid may include a dome-shaped cover cap. This cover cap can separate the second cooling section with the cooling element inside from the product contained in the cooling container. The air enclosed in the cover cap further protects the decoration from cooling below 0° C. because air is a poor conductor of heat. This prevents the upper portion of the product, in the case of an ice cream product the cream or decoration, from being inadvertently touched and damaged. The cover cap can be latched to the insert or base body. This firmly holds the cover cap on the insert or base body and protects the top portion of the product until the cover cap is removed for consumption. Two complementary latching elements may be arranged on the cover cap, on the one hand, and on the insert or base body, on the other hand. For example, a latching projection on the cover cap engages a latching slot of the insert. At least one of the latching elements can be arranged on a displaceable wall, wherein the snap-engagement can be released by changing the position of the wall. For example, an edge of the latching slot may be disposed in one of the cardboard walls that is perforated and tearable. Tearing out the portion bounded by the perforation releases the latching. For example, an edge of the latching slot may also extend near a crease line along which the displaceable wall is foldable. Thus, by folding the wall, the latching connection is released.

In practice, the insert of the base body of the cooling container can have a pull tab with which it can be pulled out of the base body together with the cup held therein. The cup, filled with ice cream and decoration such as cream on top, therefore does not have to be gripped itself, but can be pulled out of the base body of the cooling container with the aid of the pull tab. In practice, a latching opening of the insert can interacting as a first latching element with a latching projection on the cover cap as a second latching element. In this case, the latching opening can be arranged on the pull tab of the insert, wherein the pull tab can be folded down when the insert is removed from the base body, thereby releasing the latching projection. The insert is therefore first removed from the base body by pulling on the pull tab and then the latching connection between the cover cap and the insert is released by folding down the pull tab.

As mentioned, in practice the insert may also consist of a flat blank, in particular a cardboard blank. The blank may have a support wall with an opening for receiving the cup, and a plurality of side walls connected to the support wall by crease lines. In the assembled cooling container, the side walls hold the support wall at a distance from a bottom wall of the base body. This distance may form the first cooling section in which the cold cooling element is received. However, the cold cooling element may also be located below the bottom wall of the base body in a separate partitioned space. After the insert has been removed from the base body, the side walls can be unfolded and the support wall can be pushed down until it is at the bottom of the received product, in particular the ice cream cup. The ice cream cup can then be easily removed. In practice, the side walls may be resiliently springy such that when the insert is received in the base body, they are resiliently pressed against the outer walls of the base body and spring up when the insert is removed from the base body. This movement makes it easier for the user to fully spread open the side walls of the insert and remove the cup by simply pressing down on the support wall.

In a reusable variant of the cooling container, its components may be made of resistant material such as plastic or metal, in particular aluminum or stainless steel. In this variant, the base body or the lid or both components of the cooling container may have a region with a plurality of walls between which a closed cavity is formed. As explained above, the cavity may be filled with a cooling liquid. In this case, the cooling liquid forms the cooling element introduced into the cooling container. Alternatively, the cavity may be filled with air or another gas of low thermal conductivity. This gas can have a negative pressure and optimally form a vacuum to further reduce thermal conductivity. In this case, the low thermal conductivity gas forms an insulation that avoids rapid heating of the container's receiving space. Of course, an outer cavity with thermally low conductive gas and an inner cavity with cooling liquid can also be provided adjacent to each other in the lid or the base body.

The features of the cooling container according to the invention may be individually present on the cooling container and advantageously advance it. In particular, the following features may be individually realized on the cooling container with contiguous receiving space with two-zone cooling:— the base body has at least one insert that holds the cup in the first zone;
the insert in the base body has a cavity surrounding the cup, which forms a first cooling element;
the lid has a dome-shaped cover cap;
the cover cap has a cavity forming a second cooling element;
the cover cap can be latched to the insert or the base body;
two complementary latching connector elements are arranged on the cover cap on the one hand and on the insert or base body on the other;
at least one latching element is arranged on a displaceable wall, wherein the latching can be released by changing the position of the wall;
the displaceable wall is perforated and can be torn out;
the displaceable wall can be folded along a crease line.

Further practical embodiments and advantages of the invention are described below in connection with the drawings.

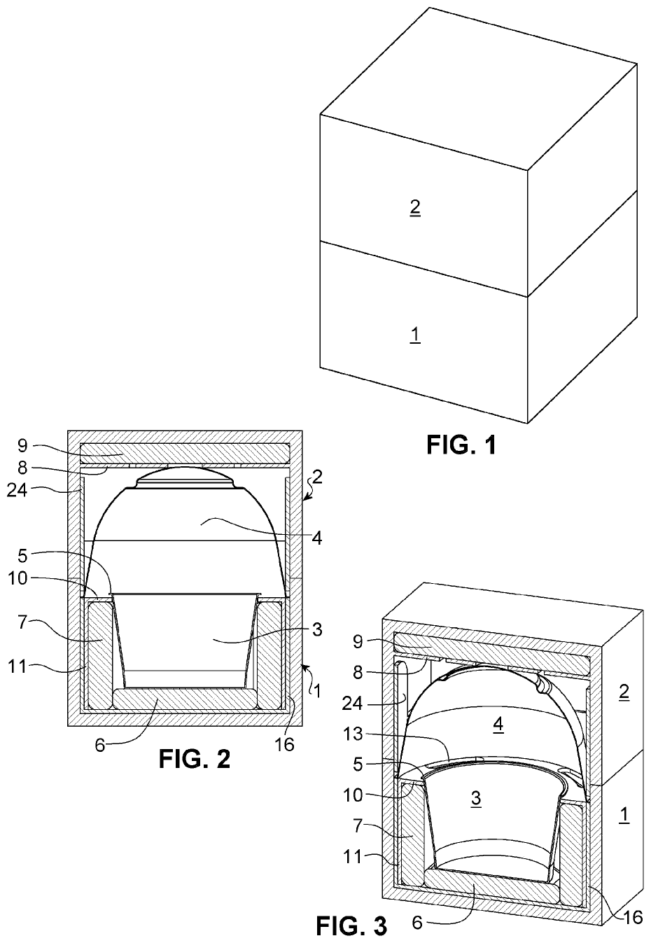

FIG. 1 shows a three-dimensional front view of a cooling container described here;

FIG. 2 shows a sectional view of the cooling container from FIG. 1;

FIG. 3 shows a three-dimensional sectional view of the cooling container from FIG. 1;

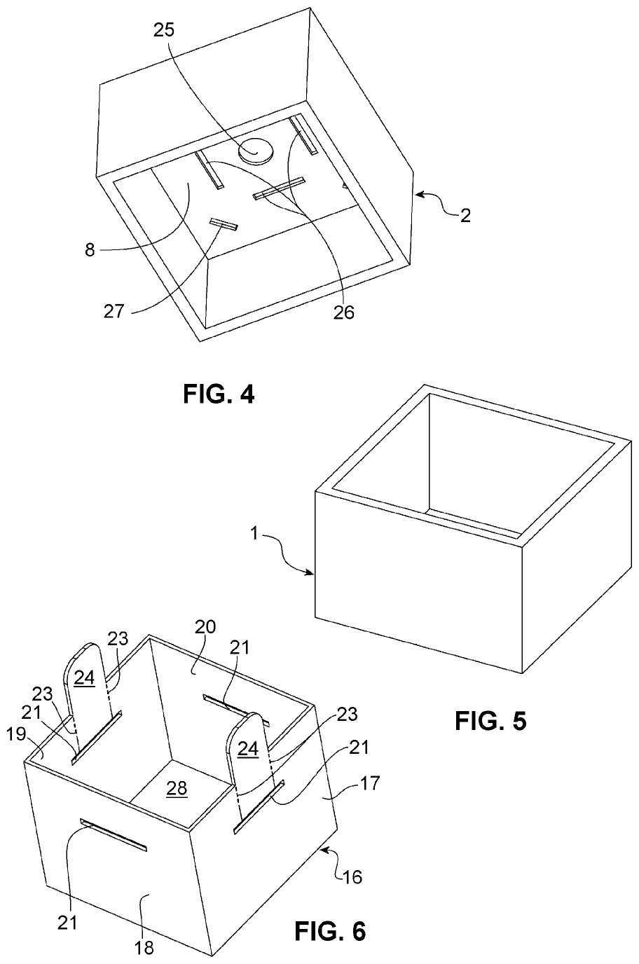

FIG. 4 shows a three-dimensional view of the lid of the cooling container from FIG. 1, viewed obliquely from below;

FIG. 5 shows a three-dimensional view of the base body of the cooling container from FIG. 1, viewed obliquely from above;

FIG. 6 shows a three-dimensional oblique top view of an insert of the cooling container;

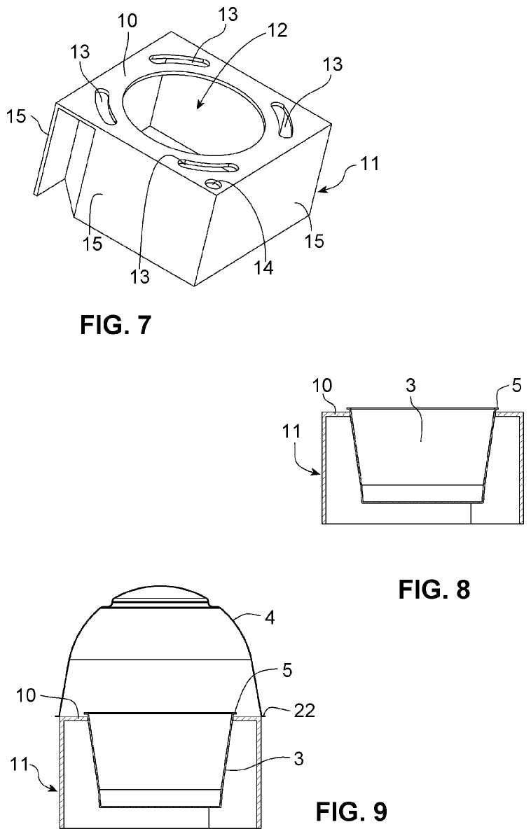

FIG. 7 shows a three-dimensional oblique plan view of a further insert of the cooling container;

FIG. 8 shows a cutaway front view of the insert of FIG. 7 with a cup received therein;

FIG. 9 shows a view corresponding to FIG. 8 in which a cover cap is also shown;

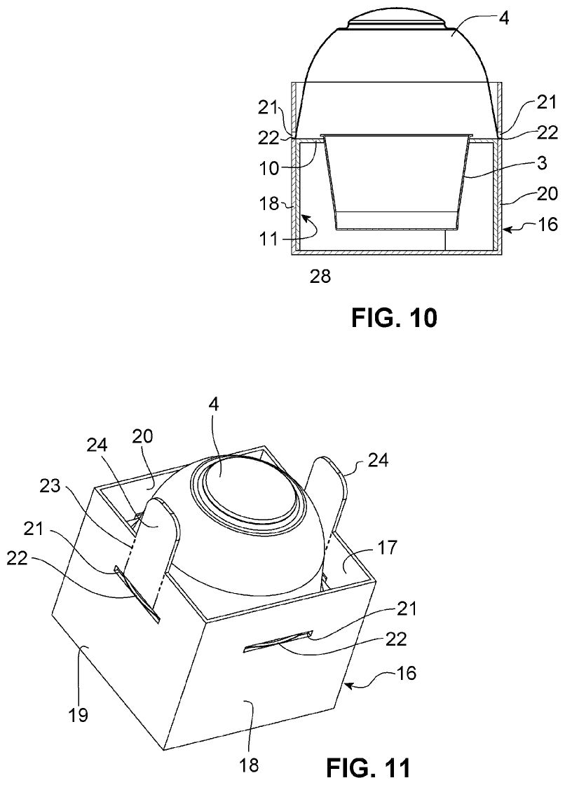

FIG. 10 shows a view corresponding to FIG. 8, in which the insert from FIG. 6 is also shown;

FIG. 11 shows a three-dimensional view of the inserts with cup and cover cap from FIG. 9;

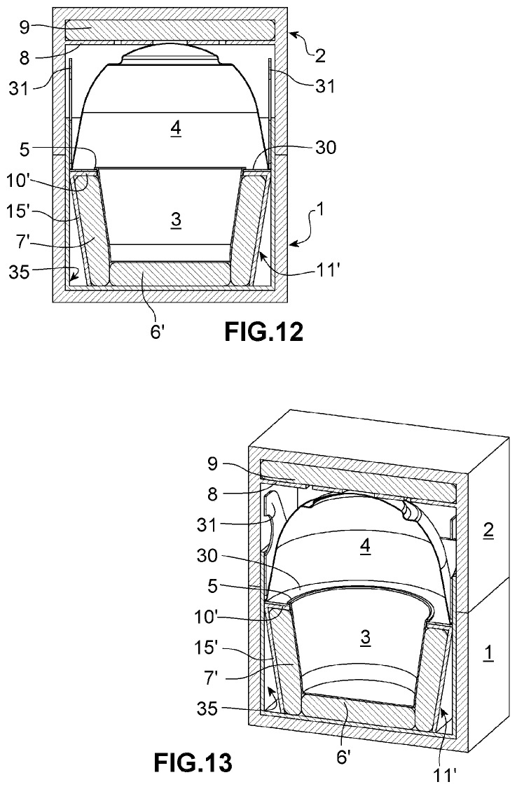

FIG. 12 shows an illustration corresponding to FIG. 2 of a second embodiment of the cooling container;

FIG. 13 shows a representation of the cooling container from FIG. 12 corresponding to FIG. 3;

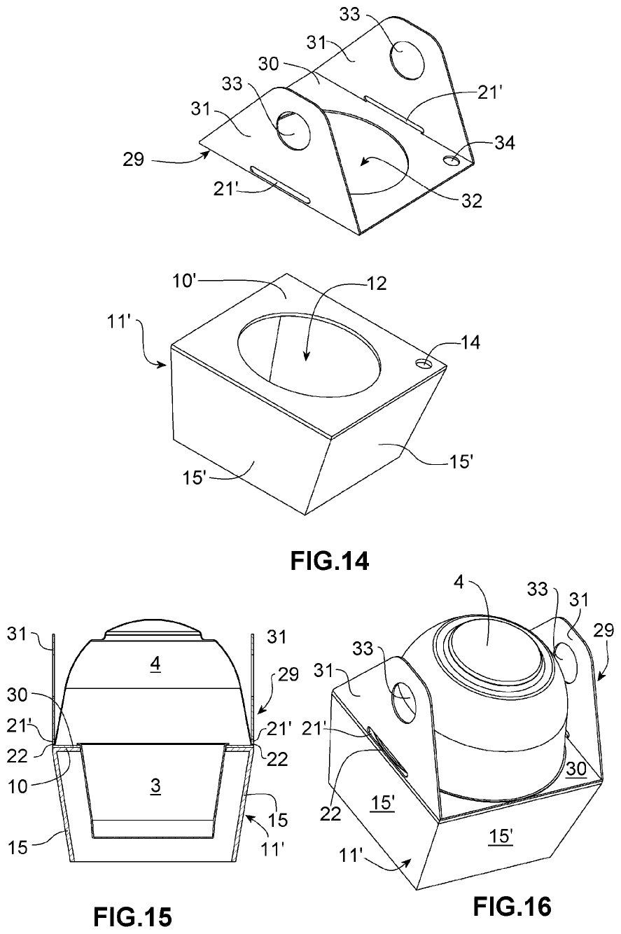

FIG. 14 shows a three-dimensional view of the two inserts of the cooling container from FIG. 12;

FIG. 15 shows a sectional view of the inserts from FIG. 14 with cup and cover cap;

FIG. 16 shows the arrangement from FIG. 15 in three-dimensional top view;

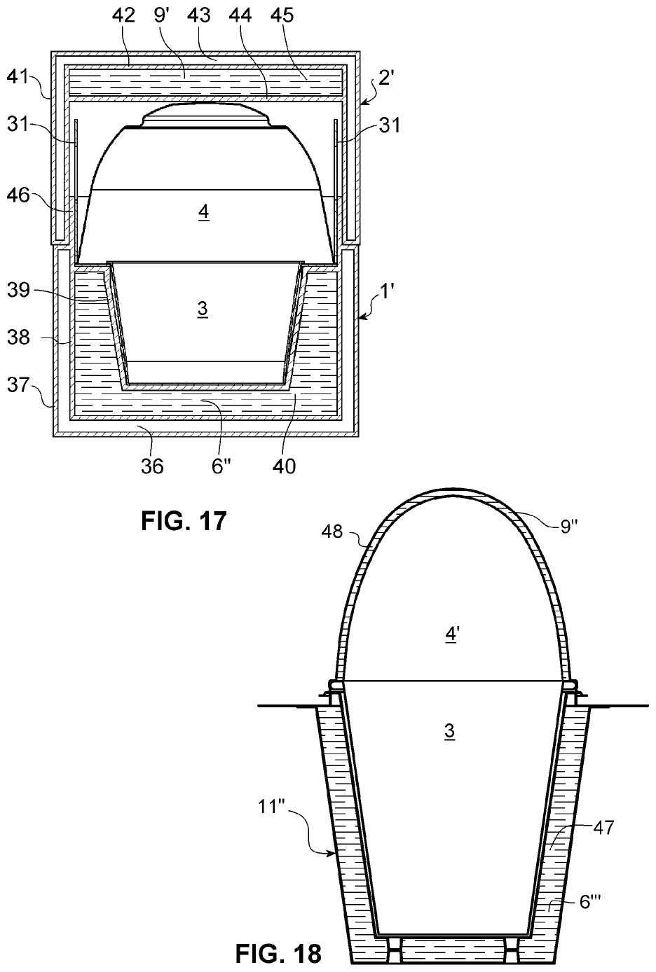

FIG. 17 shows a view corresponding to FIG. 12. of a variant of a cooling container made of resistant material;

FIG. 18 shows a variant of an insert containing a receiving space for a PCM cooling liquid.

FIGS. 1 to 11 show a first embodiment of a cooling container which enables the two-zone cooling described here. As can be seen in FIG. 1, the cooling container consists of a base body 1 and a lid 2 and has the shape of a cuboid. Both the lid 2 and the base body 1 have the shape of a cuboid shell. The base body 1 and the lid 2 can be joined together in a substantially sealed manner and together enclose the receiving space. The shape of the cooling container shown in the drawings is variable and may differ from the cuboid shape shown. For example, the cooling container may be cylindrical or have another shape. The material can also be variable. Cardboard, plastic, in particular foam, but also glass or metal are suitable for producing the outer wall of the cooling container.

The outer wall of the base body 1 is shown in FIG. 5. The insulated lid 2 can be seen in FIG. 4. The base body 1 and the lid 2 may be made of an insulating synthetic foam. Foamed plastics based on polymerized lactic acid are known which are suitable for this purpose and are completely biodegradable. It is also possible to make such cuboidal trays from corrugated cardboard. When selecting the material, care should be taken to ensure that sufficient thermal insulation is achieved. For example, if the walls of the trays are made of corrugated cardboard, they can be produced with multiple layers to achieve the desired insulation.

FIGS. 2 and 3 each show a cross-section of the cooling container of FIG. 1 with cup 3 inserted therein and a cover cap 4 which protects the contents of the cup 3 and in particular the decorations located above the cup rim 5. The cup 3 is intended to be filled with ice cream. The decoration of the ice cream, namely whipped cream, pieces of fruit or fruit sauces, fine pastries, chocolate or the like, is applied to the ice cream above the cup rim 5. This decoration is located inside the cover cap 4 and is protected by it against accidental contact.

A first cooling section is formed inside the base part 1, which is bounded by the bottom wall and the side wall of the cup 3 and by the bottom wall and the side wall of the base part 1. Two cooling elements 6 and 7 are arranged in the first cooling section. A first cooling element 6 has the shape of a disc and rests on the bottom wall of the base part 1, so that it is located directly below the cup 3. A second cooling element 7 has the shape of an annular sleeve and surrounds the side wall of the cup 3. Both cooling elements 6 and 7 are cooled to a low temperature that keeps the ice cream at the optimum consumption temperature. This is generally between −14 and 18° C. The temperature of the cooling elements 6, 7 can also be selected somewhat lower if the intention is to consume the ice cream only after a longer period of time has elapsed.

A second cooling section is located in the lid 2 above a thin partition 8. A cooling element 9 is also accommodated in this cooling section. The cooling element 9 extends over substantially the entire inner surface of the cooling section within the lid 2 and can be cooled to a less low temperature. This temperature of the cooling element 9 is below the freezing point of water to cool the second cooling section to a temperature of about 0° C. to 7° C. A plurality of slots 26, 27 and an opening 25 are provided in the partition 8 to allow temperature transfer from the cooling element 9 by convection.

In this way, in the area above the cooling element 6 and inside the sleeve-shaped cooling element 7, a first zone is created, which is cooled to a lower temperature, which essentially corresponds to the consumption temperature of the ice cream. In this first zone is inserted the cup 3 which holds the ice cream. Above the cup 3 and inside the cover cap 4, a second cooling zone is created which is cooled to a second, significantly higher temperature. The second temperature is above the freezing point of water, for example 0 to 7° C. Cream and decorations on the ice cream are thus prevented from freezing. This preserves their original consistency and high quality.

In FIGS. 2, 3, 7, 8, 9 and 10, it can be seen that the cup 3 is supported by a support wall 10 which is part of a first insert 11. The support wall 10 of the first insert 11 has a large central opening 12 for this purpose. The rim 5 of the cup 3 has an outer diameter that is larger than the diameter of the opening 12. The rim 5 thus rests on the area of the support wall 10 surrounding the opening 12 and ensures that the cup 3 does not fall through the opening 12.

The support wall 10 delimits the cooling section inside the base part 1 at the top. The support wall 10 can be seen in particular in FIG. 7, in which the insert 11 is shown in its entirety. The insert 11 consists essentially of four side walls 15, which extend downwardly from the edges of the support wall and support the support wall 10 in this manner. Air passages 13 and a receiving opening 14 are provided in the support wall 10 around the large central opening 12. The air passages 13 are arranged immediately above the sleeve-shaped cooling element 7. They allow the sleeve-shaped cooling element 7 to cool not only the cup 3, but also the cooling zone inside the cover cap 4 by convection. In practice, therefore, cooling according to the method described here is also achieved with a low temperature inside the cup 3 and a higher temperature inside the cover cap, but below the ambient temperature outside the cooling container, even if no cooling element is arranged in the lid 2. The cooling by the cooling element 7, which surrounds the cup 3 and is cooled to a low temperature, may also be sufficient to cool the cooling zone in the lid 4. An accessory such as an ice cream spoon or a straw can be inserted into the receiving opening 14 of the support wall 10.

All cooling elements 6, 7, 9 are preferably filled with a liquid in order to maintain their temperature for as long as possible. In particular, a phase change cooling liquid (phase change material, PCM) is suitable for creating a cooling container that maintains the specified temperatures in the 2 zones for a long period. In principle, the cooling effect can also be brought about by other coolants, for example dry ice. In this case, however, direct or too close contact with the dry ice must be avoided and the receiving chamber must be separated from the dry ice by partitions, if necessary thermally insulating partitions, to such an extent that the two zones in the receiving chamber do not fall below the desired different temperatures.

The cover cap 4 is latched to a second insert 16. The insert 16 is shown in FIG. 6. The second insert 16 is inserted into the base body 1, also has the shape of a rectangular shell. Its side walls 18-21 lie against the outer wall of the base body 1. The second insert 16 contains the cooling elements 6,7, and the first insert 11 with the cup 3 held therein is inserted therein (see FIG. 10). The cooling element 6 rests on the bottom wall 28 of the second insert 16.

The side walls 16-20 of the second insert 16 (see FIG. 6) have horizontal slots 21 which form latching openings for the rim 22 of the cover cap 4. The portions of the rim 22 of the cover cap 4 located in the regions of the latching openings 21 form latching projections which engage in the latching openings 21 and thus secure the cover cap 4.

FIGS. 8 to 11 show the assembly of the illustrated cooling container. The first insert 11 accommodates the cup 3. For this purpose, the cup 3 protrudes through the central opening 12 in its support wall 10. The cup rim 5 rests on the support wall 10 in the area surrounding the opening 12, so that the cup 3 is held by the support wall 10 (see FIG. 8). The cup 3 is covered by the cover cap 4. This is shown in FIG. 9. It can be seen that the diameter of the cover cap 4 is considerably larger than the diameter of the cup 3. The cover cap 4 also has a radially projecting rim 22. The rim 22 of the cover cap 4 forms a latching projection. As can be seen in FIGS. 10 and 11, the insert 11 is inserted into the insert 16. The support wall 10 is located at the level of the lower edges of the slots 21 in the side walls 17-20 of the insert 16. When the cover cap 4 is fitted, the rim 22 of the cover cap 4 is elastically compressed and resiliently engages in the slots 21 of the side walls 17-20 of the insert 16. In particular, it can be seen in FIGS. 6 and 11 that the material regions of the side walls 17 and 19 above the slots 21 are separated by perforation lines 23. Tear tabs 24 extend above these perforation lines 23, and the tear tabs 24 can be torn off along the perforation lines 23. Now the cover cap 4 can be removed, because the slots 21 located in the area of the torn-off tear tabs 24 no longer engage with the rim 22 of the cover cap 4, which forms the latching projection. The tear tabs 24 thus form the displaceable wall which releases the latching opening.

An alternative design of the cooling container is shown in FIGS. 12 to 16. Identical parts are provided with the same reference signs here. In particular, it can be seen in FIGS. 12 and 13 that the sleeve-shaped cooling element 7′ tapers downwards approximately in the form of a conical section and thus follows the contour of the cup 3. The lower cooling element 6′ extends in the region of the base of the cup 3 and has a smaller diameter than in the first embodiment.

The inserts 11′, 29 of this embodiment of the cooling container are shown in FIG. 14. The first insert 11′ corresponds essentially to the first insert 11 of the first embodiment. It has a central opening 12 in the upper support wall 10′ for receiving the cup 3. This insert 11′ is also called cup insert or hole insert. The support wall 10′ is also provided with a receiving opening 14, but unlike the first embodiment, it does not have air passages. The side walls 15′ of this insert 11′ run downward at a slight angle so that they essentially follow the contour of the slightly conical cooling element 7′.

A removal insert 29 rests on the insert 11′, which can be used as a removal aid for the filled cup 3 from the base part 1 of the cooling container. The removal insert 29 has a horizontal transverse wall 30 which is adjoined by two kinked pull tabs 31. In the transverse wall 30 there is a cup opening 32 through which the cup 3 is inserted. Above the crease lines, the pull tabs 31 have slots 21′. The transverse wall 30 also has a receiving opening 34. A gripping opening 33 is provided in each pull tab 31.

In FIGS. 15 and 16, it can be seen that the removal insert 29 is placed on the first insert 11′ so that the openings 32, 34 in the transverse wall of the removal insert 29 are aligned with the openings 12, 14 in the support wall 10′ of the first insert 11′. The cup 3 is inserted through the openings 32 and 12. The cover cap 4 is placed on the transverse wall 30. The pull tabs 31 are folded up. The slots 21′ in the pull tabs 31 form the snap-in openings for the rim 22 of the cover cap 4.

The pull tabs 31 are folded up and protrude from the base part 1 of the cooling container. They can be pulled upward to remove the cup 3. The rim 5 of the cup 3 rests on the transverse wall 30 of the removal insert 29. After the cup 3 has been removed, it can be placed on a table. The pull tabs 31 form a displaceable wall and can be folded away laterally. This releases the engagement of the rim 22 of the cover cap 4 in the slots (latching openings) 21′ of the pull tabs 31. The removal insert 29 can then be pushed to the bottom of the cup and the cup 3 can be gripped.

It will be apparent to those skilled in the art that the cooling container may include further functional inserts. For example, it can be seen in FIGS. 12 and 13 that the first insert 11′ and the lower portion of the pull tabs 31 are surrounded by a further wrapping insert 35 which connects the other inserts 11′, 29 and the cooling elements 6′, 7′ to form a unit which can be easily inserted into the base part 1 of the cooling container.

All inserts of the cooling containers, except for the removal insert 29, may be glued together, e.g. by double-sided adhesive tape.

FIG. 17 shows a variant of the cooling container intended for multiple use. This variant is shown in a sectional view corresponding to FIG. 12. Identical components have the same reference signs here. In particular, the cup 3, the cover cap 4 and the removal insert with the pull tabs 31 are designed as in the preceding embodiment of FIGS. 12-16.

In the variant of FIG. 17, the base body 1′ and the lid 2′ in this reusable embodiment can be made of resistant material, in particular a plastic or metal. The resistant material enables repeated cleaning of the base body 1′ and lid 2′. Further, the resistant material exhibits substantial strength and allows the base body 1′ and the lid 2′ to be made with thin walls, wherein at least one cavity may be formed between the thin walls. In the embodiment shown in FIG. 17, the base body 1′ has a first cavity 36 extending along its outer wall 37. This cavity 36 is bounded inwardly by the wall 38 and is filled with air. This cavity 36 may be sealed from the environment and have air with a negative pressure. Air is a medium with low thermal conductivity, especially when filled with a low pressure. Consequently, the cavity 36 reduces the heating of the receiving space located inside the base member 1′ and protects the outer wall of the base member 1′ against excessive cooling.

A further cavity 40 can be formed between the wall 38 and the inner wall 39 of the base body 1′. PCM cooling liquid can be filled into this cavity 40. The PCM cooling liquid forms a cooling element 6″ inside the base body 1′. The cup 3 can then be placed in the inner wall 39 of the base body 1′.

The lid 2′ of the cooling container of FIG. 17 may be formed in a similar manner. An outer wall 41 and an inner wall 42 define a cavity 43 which is filled with air. In the upper region of the lid 2′, a third wall 44 is provided which, together with the wall 42, delimits a cavity 45 for receiving a cooling liquid which can form the second cooling element 9′ in the lid 2.

The base body 1′ can have an upper connecting wall 46 which can be inserted into the lower region of the lid 2′ and seals the interior of the cooling container to the outside. Additionally, seals (not shown) can be provided which increase the tightness. Also, if required, connecting elements (not shown) can be provided which detachably connect the lid 2′ and the base body 1′ to each other so that the cooling container can be resealed. Such connecting elements may be, for example, threaded or buckle connections. An elastic band can also be used to elastically clamp the lid 2′ and the base body 1′ against each other. A flexible outer layer (not shown) of insulating material such as rubber or plastic can also be applied to the outer wall of the cooling container to prevent the cooling container from being too cold when touched.

FIG. 18 shows an alternative embodiment of an insert 11″, which is double-walled so that it has a closed cavity 47. The insert 11″ can be made of plastic, for example. A cooling liquid (for example a PCM liquid) is filled in the cavity 47 of the insert. The insert 11″ thus forms the first cooling element 6′″. The cooling effect of this insert 11″ is very good, because the cup 3 can be inserted in this insert 11″ without considerable play and the temperature of the cooling element 6′″ is transferred to the cup 3 without losses. Optimally, the cup 3 is in direct contact with the inner wall of the cooling element 6′″, so that the temperature is transferred from the cooling element 6′″ to the cup 3 via heat conduction.

Similarly, in the embodiment of FIG. 18, the cover cap 4′ may be double-walled with a cavity 48 in which cooling liquid is filled to form the second cooling element 9″. However, if the cooling effect of the first cooling element 6′″ is sufficiently high, a second cooling element 9″ in the cover cap 4′ can also be dispensed with. The insert 11″ and the cover cap 4′ are inserted in the closed state shown in FIG. 18 into the base body 1 and the lid of FIG. 13. In this packaging, it is desirable that at least insert 11″ and cover cap 4″ be returned to the supplier to ensure multiple use of the cooling elements 6′″ and 9″. When used in an ice cream parlor, these cooling elements 6′″ and 9″ can be frozen many times (up to 100 times) to serve as cooling elements of a transport package for ice cream. An upper wall of the insert 11″ may cover the interior of the base portion of the package. The cup 3 may be slightly higher than the interior of the base portion, so that its rim projects upwardly above the upper wall of the insert 11″ and may be easily grasped by the user. The cover cap 4′ here has a relatively small size. If the cover cap is to cover large-volume decorative elements, it can also have a larger diameter, such as the cover cap 4 in FIG. 17, or have a different larger shape than the cover cap 4′ shown in FIG. 18.

The cover cap in the illustrated embodiments extended only over the area of the second, upper cooling zone. However, the cover cap is not limited to this. It can also be larger and partially or completely surround the first cooling zone.

The features of the invention disclosed in the present description, in the drawings as well as in the claims may be essential, both individually and in any combination, for the realization of the invention in its various embodiments. The invention is not limited to the embodiments described. It may be varied within the scope of the claims and with due regard to the knowledge of the person skilled in the art.

### LIST OF REFERENCE SIGNS

1, 1′ Base part
2, 2′ Lid
3 Cup
4, 4′ cover cap
5 Cup rim
6, 6′, 6″, 6′″ Cooling element
7, 7′ Cooling element
8 Partition
9, 9′, 9″ Cooling element
10, 10′ Support wall
11,11′,11″ first insert
12 central opening
13 Air passage
14 receiving opening
15, 15′ side wall
16 second insert
17 Sidewall
18 Sidewall
19 Sidewall
20 Sidewall
21, 21′ slot, latching opening
22 Rim, latching projection
23 Perforation line
24 Tear tab
25 Opening
26 Opening
27 Opening
28 Bottom wall
29 Removal insert
30 transverse wall
31 Pull tab
32 Cup opening
33 Gripping opening
34 Receiving opening
35 Wrapping insert
36 Cavity
37 Outer wall
38 Wall
39 inner wall
40 Cavity
41 outer wall
42 Wall
43 Cavity
44 inner wall
45 Cavity
46 Connecting wall
47 Cavity
48 Cavity

1. Method for cooling a product, in particular an ice cream product, in which at least one cooling element (6, 7, 6′, 7′, 6″, 6′″, 9, 9′, 9″) is introduced into a cooling section of a cooling container and in which the product is introduced into a receiving space of the cooling container,
characterized in that
the receiving space is divided into two zones and the first, lower zone of the receiving space is cooled to a first temperature below −10° C. and the second, upper zone of the receiving space is cooled to a second temperature which is near or above the freezing point of water.

2. Method according to claim 1, characterized in that at least one first cooling element (6, 6′, 6″, 6′) having a first temperature is introduced into a first cooling section of the cooling container adjacent to the first zone, and in that at least one second cooling element (9, 9′, 9″) having a second temperature is introduced into a second cooling section of the cooling container adjacent to the second zone.

3. Method according to claim 1, characterized in that the first cooling section and the first zone are arranged in a base body (1, 1′) of the cooling container, that the second cooling section and the second zone are arranged in a lid (2, 2′) of the cooling container and that the product is placed in the base body (1, 1′) and the lid (2, 2′) is placed on the base body (1, 1′) in such a way that the receiving space is closed.

4. Method according to claim 3, characterized in that at least one insert (11, 16, 11′29, 35, 11″) is introduced into the base body (1, 1′) and a dome-shaped cover cap (4, 4′) is introduced into the lid, and in that the cover cap (4) is latched to the base body (1, 1′) or to the insert (11″, 16, 29).

5. Method according to claim 4, characterized in that two mutually complementary latching elements (21, 21′, 22) are brought into engagement with one another, which are arranged on the one hand on the cover cap (4) and on the other hand on the insert (16, 29) or the base body (1), and in that at least one latching element (21) is arranged on a displaceable wall (24, 31), the latching being released by changing the position of the wall (24, 31).

6. Method according to claim 3, characterized in that at least one pull element (31) is arranged in the cooling container and the product is moved out of the base body (1) by pulling on the pull element (31).

7. Method according to claim 1, characterized by at least one of the following steps:
the first zone is cooled to a temperature below −10° C.;
the first zone is cooled to a temperature of about −14° C.;
the second zone is cooled to a temperature above freezing;
the second zone is cooled to a temperature of about 0° C. to 7° C.

8. Method according to claim 1, characterized in that the receiving space has at least one region with a plurality of parallel walls (37, 38, 39, 41, 42, 44), wherein a cooling liquid is filled into the cavity between the walls for introducing the cooling element (6″, 7″) or a thermally low conductive medium is filled in for thermal insulation of the receiving space.

9. Cooling container with at least one receiving space for a product and a cooling sector adjacent to the receiving space for receiving a cooling element (6, 7, 6′, 7′), characterized in that at least two cooling sectors are adjacent to the receiving space, into which cooling elements (6, 7, 6′, 7′) can be introduced which cool the receiving space to two different temperatures in at least two zones.

10. Cooling container according to claim 9, characterized in that it comprises a base body (1) made of a thin-walled material having a first zone for receiving a cup (3) surrounded by a first cooling sector, and in that it comprises a lid (2) made of a thin-walled material having a second zone surrounded by a second cooling sector.

11. Cooling container according to claim 10, characterized in that it has at least one of the following features:
the base body (1) has at least one insert (11, 11′, 11″) which holds the cup (3) in the first zone;
the insert (11″) in the base body (1) has a cavity 47) surrounding the cup (3) and forming a first cooling element (6′″);
the lid (2) has a dome-shaped cover cap (4);
the cover cap (4′) has a cavity (48) forming a second cooling element (9″);
the cover cap (4) can be latched to the insert (16, 30) or the base body (1);
two mutually complementary latching elements (21, 21′, 22) are arranged on the cover cap (4) on the one hand and on the insert (16, 30) or the base body (1) on the other;
at least one latching element (21) is arranged on a displaceable wall (24, 31), wherein the latching can be released by changing the position of the wall (24, 31);
the displaceable wall (24) is perforated and can be torn out;
the displaceable wall (31) is foldable along a crease line.

12. Cooling container according to claim 11, characterized in that the insert (11, 11′, 16, 29) has at least one of the following features:
a pull tab (31) with which the insert (29) with the cup (3) held therein can be pulled out of the base body (1);
a latching opening (21) as a first latching element, with which a latching projection (22) on the cover cap (4) interacts as a second latching element;
the latching opening (21) is arranged on a pull tab (31), wherein the pull tab (31) can be folded over when the insert (29) is removed from the base body (1), thereby releasing the latching projection (22).

13. Cooling container according to claim 11, characterized in that the insert (11, 11′) consists of a flat blank which has a support wall (10) with an opening (12) for receiving the cup (3), and which has a plurality of side walls (15, 15′) which are connected to the support wall (10) via crease lines and hold the support wall (10) at a distance from a bottom wall of the base body (1).

14. Cooling container according to claim 10, characterized in that the base body (1″) and/or the lid (2″) has a region with a plurality of walls (37, 38, 39, 41, 42, 44) between which a cavity (36, 40, 43, 45) is formed.

15. Cooling container according to claim 14, characterized by at least one of the following features:
a cooling liquid is filled into the cavity (40, 45);
a thermally low conductive medium is filled into the cavity (36, 43), in particular air and in particular at a very low absolute pressure.
